(19) United States
(12) Patent Application Publication
(10) Pub. No.: US 2020/0386184 A1
(43) Pub. Date: Dec. 10, 2020

(54) THRUST REVERSER FOR AN AIRCRAFT TURBOJET ENGINE NACELLE AND ASSOCIATED NACELLE

(71) Applicant: Safran Nacelles, GONFREVILLE L'ORCHER (FR)

(72) Inventor: Patrick BOILEAU, MOISSY CRAMAYEL (FR)

(73) Assignee: Safran Nacelles, GONFREVILLE L'ORCHER (FR)

(21) Appl. No.: 16/871,271

(22) Filed: May 11, 2020

Related U.S. Application Data
(63) Continuation of application No. PCT/FR2018/052800, filed on Nov. 9, 2018.

(30) Foreign Application Priority Data
Nov. 10, 2017 (FR) 1760589

(51) Int. Cl. F02K 1/72

(52) U.S. Cl. CPC F02K 1/72; F05D 2220/32

(57) ABSTRACT

A thrust reverser for a turbojet engine nacelle includes a movable cowl mounted on a structure of the reverser, movable between a closed position an open position. The thrust reverser includes thrust reversal flaps actuated by sliding the movable cowl, and movable between a retracted position, in which the flaps are aligned with an inner wall of the movable cowl and housed in a housing of the movable cowl when the movable cowl is in the closed position, and a deployed position, in which the flaps are arranged to at least partially obstruct a cold stream flow path to divert at least part of the flow towards an open passage, when the movable cowl is in the open position. The housing of the movable cowl is defined by a wall of the movable cowl formed at least partially by an acoustic attenuation panel.

### CROSS-REFERENCE TO RELATED APPLICATIONS

This application is a continuation of International Application No. PCT/FR2018/052800, filed on Nov. 9, 2018, which claims priority to and the benefit of FR 17/60589 filed on Nov. 10, 2017. The disclosures of the above applications are incorporated herein by reference.

### FIELD

The present disclosure relates to a thrust reverser for an aircraft turbojet engine nacelle and is situated more precisely in the field of acoustic attenuation of an aircraft propulsion unit, that is to say the unit formed by a turbojet engine (in particular a bypass turbojet engine) equipped with a nacelle, the propulsion unit possibly including the engine pylon.

### BACKGROUND

The statements in this section merely provide background information related to the present disclosure and may not constitute prior art.

An aircraft is moved by several turbojet engines each housed in a nacelle serving to channel the air flow generated by the turbojet engine which also accommodates a set of actuating devices ensuring various functions when the turbojet engine is in operation or at stop.

These actuating devices may comprise, in particular, a mechanical thrust reversal system.

A nacelle generally has a tubular structure comprising an air inlet upstream of the turbojet engine, a median portion intended to surround a fan of the turbojet engine, a downstream portion accommodating thrust reversal means and intended to surround the combustion chamber of the turbojet engine, and is generally terminated by an ejection nozzle whose outlet is located downstream of the turbojet engine.

Modern nacelles are intended to accommodate a bypass turbojet engine capable of generating via the blades of the fan, an air flow portion of which, called hot or primary flow, circulates in the combustion chamber of the turbojet engine, and the other portion of which, called cold or secondary air flow, circulates outside the turbojet engine through an annular passage, also called flow path, formed between a fairing of the turbojet engine and an inner wall of the nacelle. The two air flows are ejected from the turbojet engine by the rear of the nacelle.

The role of a thrust reverser is, during the landing of an aircraft, to improve the braking capacity thereof by redirecting forward at least a portion of the thrust generated by the turbojet engine. In this phase, the thrust reverser obstructs the cold air flow path and directs the latter forward of the nacelle, thereby generating a counter-thrust in addition to the braking of the aircraft wheels.

The means implemented to achieve this reorientation of the cold air flow vary depending on the type of thrust reverser. However, in all cases, the structure of a thrust reverser comprises movable cowls (or doors) displaceable between a closed or “direct jet” position in which they close this passage and an open or “reverse jet” position in which they open in the nacelle a passage intended for the diverted flow.

In the case of a cascade thrust reverser, also known as a cascade reverser, the reorientation of the air flow is performed by cascade vanes, the cowl having only a simple slide function aiming at uncovering or covering again these cascade vanes.

The translation of the cowl is performed along a longitudinal axis substantially parallel to the axis of the nacelle. Thrust reverser flaps, actuated by the sliding of the cowl, allow an obstruction of the cold air flow path downstream of the cascade vanes, so as to optimize the reorientation of the cold air flow towards the outside of the nacelle.

Such a cowl may either:

have an almost annular shape, extending without interruption from one side to the other of a suspension mast of the assembly formed by the turbojet engine and its nacelle, such a cowl being called “O-duct,” referring to the shroud shape of such a cowl, or

actually comprise two half-cowls each extending over a semi-circumference of the nacelle, such a cowl being called “D-duct.”

The sliding of a cowl between its “direct jet” and “reverse jet” positions is conventionally provided by a plurality of actuators, of the electro-mechanical type (for example: worm screw actuated by an electric motor and displacing a nut) or of the hydraulic type (cylinders actuated by oil under pressure).

In such an aircraft propulsion unit, the acoustic attenuation is generally carried out by means of acoustic attenuation panels. Such panels can take the form of a sandwich structure, including a cellular core framed between two skins, one solid and the other perforated so as to be acoustically porous. The perforated skin, generally called acoustic skin, is intended to be in contact with the cold air flow passing through the nacelle and/or with the flow of hot gases ejected by the turbojet engine.

Acoustic attenuation panels with one degree of freedom of acoustic waves are known as SDOF acoustic panels (for “Single Degree Of Freedom”). Such panels take the form of a sandwich structure as described hereinabove.

Acoustic attenuation panels with two degrees of freedom are also known as 2 DOF acoustic panels (or DDOF, for “Double Degree Of Freedom”). Unlike SDOF type panels, DDOF type panels comprise a two-stage cellular structure, these stages being separated by an acoustically porous wall commonly called a septum. As for the panels previously described, this cellular structure is sandwiched between an acoustically reflective skin and an acoustically porous skin. DDOF type panels have the advantage of attenuating acoustic waves over a frequency band wider than an SDOF type panel.

Generally, the height of the cellular structure (and therefore the height of the cavities it includes) and the porosity of the acoustic skin and, if necessary, of the septum are optimized so as to maximize the acoustic attenuation and to target the right range of sound frequencies.

On the other hand, the larger the surface area acoustically treated within a propulsion unit (and in particular within a nacelle), the better the overall performance of the acoustic attenuation. Manufacturers are therefore making permanent efforts to increase the acoustically treated surface, in particular equipping the thrust reverser flaps of the acoustic panels.

FIGS. 1A and 1B show a view of a propulsion unit including a nacelle 1 surrounding a bypass turbojet engine, the unit being secured to an engine pylon 5 (visible only in FIG. 1B). The nacelle 1 conventionally includes an air inlet 2, a median section 3, as well as a rear section 4. FIG. 1A shows the nacelle 1 in the “direct jet” configuration, that is to say with the thrust reversal system in the retracted position, while FIG. 1B shows the nacelle in the “reverse jet” configuration, that is to say with the thrust reversal system in the deployed position. Thus it can be seen in FIG. 1B that a movable cowl 20 of the rear section 4 is in the receded position, revealing a set of thrust reverser cascades 21.

FIGS. 2A and 2B show a cross-section of the rear section 4 of the nacelle 1, respectively when the thrust reversal system is in the retracted position (or direct jet) and in the deployed position (or reverse jet).

The thrust reversal system comprises a movable cowl 20, which forms the external surface of the rear section 4 of the nacelle. The thrust reversal system further comprises thrust reverser cascades 21 and thrust reverser or blocking flaps 22, rotatably movable, and associated with connecting rods 23. The thrust reversal system includes actuators (not represented), in particular electromechanical actuators, allowing to slide the movable cowl between a retracted position (FIG. 2A) and a deployed position (FIG. 2B), and vice versa.

This translation is performed along a longitudinal axis of the nacelle, corresponding to the longitudinal axis of the engine.

When the thrust reversal system is in the retracted position (FIG. 2A):

the movable cowl 20 is in the retracted position, corresponding to an advanced position in which it ensures the aerodynamic continuity with the median section of the nacelle;

the thrust reverser flaps 22 are in the retracted position, a position in which they are aligned with the inner surface of the movable cowl 20, and housed in a housing 27 of the movable cowl 20;

When the thrust reversal system is in the deployed position (FIG. 2B):

the movable cowl is in the deployed position, corresponding to a receded position, in which it uncovers the thrust reverser cascades 21;

the thrust reverser flaps 22 are in the deployed position, a position in which they at least partially obstruct the flow path 24 of the cold flow.

In this configuration, the action of thrust reverser flaps 22 and thrust reverser cascades 21 allows to redirect the cold flow outside the nacelle, towards the front in order to create a counter-thrust. The passage in the deployed position of the thrust reverser flaps 22 is in the example obtained by the action of connecting rods 23 attached to an inner fixed structure 25 of the nacelle.

It is known to provide an acoustic attenuation panel 26 on thrust reverser flaps 22. Examples of acoustically treated thrust reverser flaps 22 are represented in FIGS. 3A and 3B, which show a longitudinal sectional-view of a thrust reverser flap. FIGS. 3A and 3B thus show a thrust reverser flap 15 equipped with an acoustic attenuation panel 26, respectively with a single degree of freedom and a double degree of freedom.

In FIG. 3A, it can be seen that the acoustic attenuation panel 26 with a single degree of freedom includes a solid rear skin 28 and a front skin 29, these two skins framing a cellular core 30. The front skin 29 is multi-perforated and therefore acoustically porous. The front skin 29 forms the outer surface of the thrust reverser flap.

The search for maximum noise reduction in aircraft propulsion units has led manufacturers to consider acoustic attenuators with a double degree of freedom.

Thus, in FIG. 3B, the acoustic attenuation panel 26, with a double degree of freedom, is formed by a solid skin 28 and a perforated skin 29 framing a cellular core 30. Nonetheless, the cellular structure includes two stages separated by a septum 31. Thus, this allows improving the acoustic attenuation performance in particular in the medium and high sound frequencies, but leads to expensive and heavy acoustic panels.

In addition, the acoustic attenuation panel 26 being installed in the housing 27, this must be sized to be able to house the thrust reverser flaps (and therefore the acoustic attenuation panel 26), when the thrust reverser flaps are in the retracted position.

The size of the acoustic attenuation panel thus constitutes a drawback because in this example it requires increasing the dimensions of the housing, generating discontinuities in the structure of the translating cowl.

In addition, the structure of the translating cowl perpendicular to the housing of the thrust reverser flaps has a reduced thickness taking into account the thickness of said flap, which is generally constituted of a monolithic skin. Nonetheless, such a structure does not offer optimum stiffness.

### SUMMARY

This section provides a general summary of the disclosure and is not a comprehensive disclosure of its full scope or all of its features.

The present disclosure provides a thrust reverser configured to provide suitable acoustic attenuation and which allows gaining in stiffness and in structural holding.

To this end, the present disclosure relates to a thrust reverser for a turbojet engine nacelle comprising at least one movable cowl mounted on a fixed structure of the reverser between a closed position, in which it provides the aerodynamic continuity of the nacelle and an open position in which it opens a passage in the nacelle, the thrust reverser further comprising thrust reverser flaps actuated by the sliding of the cowl, and movable between:

a retracted position, a position in which they are aligned with an inner wall of the movable cowl, and housed in a housing of said movable cowl, when the movable cowl is in the closed position, and

a deployed position, position in which they are arranged to at least partially obstruct a flow path of cold flow from the nacelle to at least partially divert the flow towards the passage opened in the nacelle, when the movable cowl is in the open position,

the thrust reverser being remarkable in that the housing of the movable cowl is delimited by a wall of said movable cowl at least partially formed by an acoustic attenuation panel.

By having at least one acoustic attenuation panel at the level of the housing intended to receive the thrust reverser flaps in the closed position, this makes it possible to be able to design thrust reverser flaps whose acoustic treatment is less than that of the components of the prior art. This therefore allows to design thrust reverser flaps having a reduced thickness and to improve the stiffness and the structural holding of the movable cowl.

According to an advantageous technical characteristic, the wall of the movable cowl delimiting the housing is formed by a continuous extension of the inner wall of the movable cowl with which the thrust reverser flap is aligned when it is in the retracted position. In particular, the wall of the movable cowl delimiting the housing is formed by an acoustic attenuation panel in the extension of the acoustic attenuation panel of the inner wall of the movable cowl.

Such continuity of the inner wall which is extended to delimit the housing provided for receiving the thrust reverser flaps in the closed position allows to further improve the structural holding of the movable cowl and to limit any point of weakness and discontinuities in the structure of the translating cowl, on the contrary, for example of an attached part.

According to a particular characteristic, the wall of the movable cowl delimiting the housing is formed by an acoustic attenuation panel extending continuously from said housing which it delimits to the inner wall. In other words, the inner wall of the movable cowl is formed by an acoustic panel which extends continuously upstream so as to form the housing by delimiting it.

In such a configuration, the acoustic panel has a downstream portion of the inner wall, which is arranged to be swept by the secondary flow when the turbojet engine is in operation and the thrust reverser is in the closed position, the acoustic panel extending from the downstream portion to an upstream portion, upstream of the downstream portion, to delimit the housing provided for receiving the thrust reverser flaps in the closed position.

The acoustic panel forming the inner wall has a step between the upstream portion forming the housing and the downstream portion forming the inner wall so that, in the retracted position of the thrust reverser flaps, the latter are aligned with the inner wall of the movable cowl, in particular aligned with an inner surface of the inner wall intended to be swept by the secondary flow in operation.

Advantageously, the acoustic panels are acoustic attenuation panels with a single degree of freedom of the acoustic waves (SDOF) and/or acoustic attenuation panels with a double degree of freedom (2 DOF or DDOF).

According to a particularly advantageous characteristic, the thrust reverser flaps are generally acoustically transparent.

For the purposes of the present disclosure, the term “acoustically transparent” means a structure permeable to sound frequencies. In other words, this means that the thrust reverser flaps are not acoustically treated.

In such a configuration, the wall of the movable cowl delimiting the housing of the thrust reverser flaps being acoustically treated, it is possible to reduce the acoustic treatment of the flaps themselves. Furthermore, and surprisingly, it is possible to remove them without significantly deteriorating the acoustic balance of the thrust reverser. Moreover, this increases the overall acoustic surface of the nacelle.

In a particular configuration, the thrust reverser flaps have a pierced and/or porous surface.

According to a technical characteristic, the thrust reverser flaps are formed by a monolithic wall, and in one form are reinforced by stiffeners.

According to another aspect, the present disclosure also relates to a nacelle remarkable in that it comprises a thrust reverser as described hereinabove.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1A is a perspective view of an aircraft turbojet engine nacelle according to the prior art;

FIG. 1B is a perspective view of the aircraft turbojet engine nacelle of FIG. 1A secured to an engine pylon according to the prior art;

FIG. 2A is a cross-sectional view of the rear section of the nacelle illustrating the thrust reversal system in a retracted position according to the prior art;

FIG. 2B is a cross-sectional view of the rear section of the nacelle illustrating the thrust reversal system in a deployed position according to the prior art;

FIG. 3A is a cross-sectional view of the thrust reverser flap illustrating an acoustic attenuation panel with a single degree of freedom according to the prior art;

FIG. 3B is a cross-sectional view of the thrust reverser flap illustrating an acoustic attenuation panel with a double degree of freedom according to the prior art;

FIG. 4 is a schematic cross-sectional view of a thrust reverser according to one form of the present disclosure;

FIG. 5 is a schematic cross-sectional view of an inner panel of a movable cowl of the thrust reverser illustrated in FIG. 4;

FIG. 6 is a schematic cross-sectional view of an inner panel of a movable cowl of a thrust reverser according to another form of the present disclosure;

FIG. 7A is an exploded perspective view of a flap and a portion of the movable cowl provided with a corresponding housing provided for housing the flap according to the present disclosure; and

FIG. 7B is a cross-sectional view at lines A-A of FIG. 7A, in the assembled position.

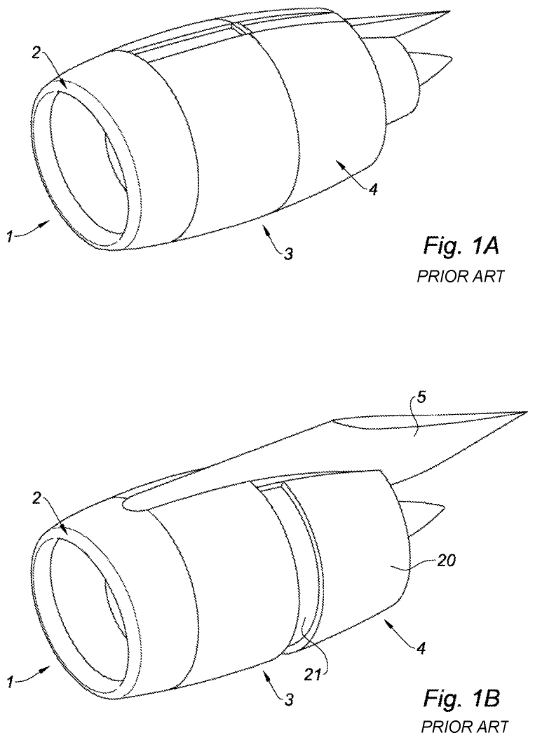

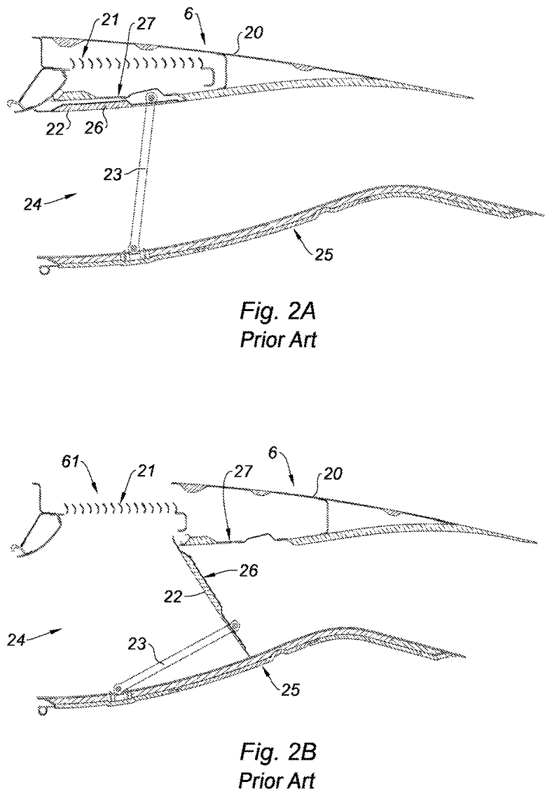

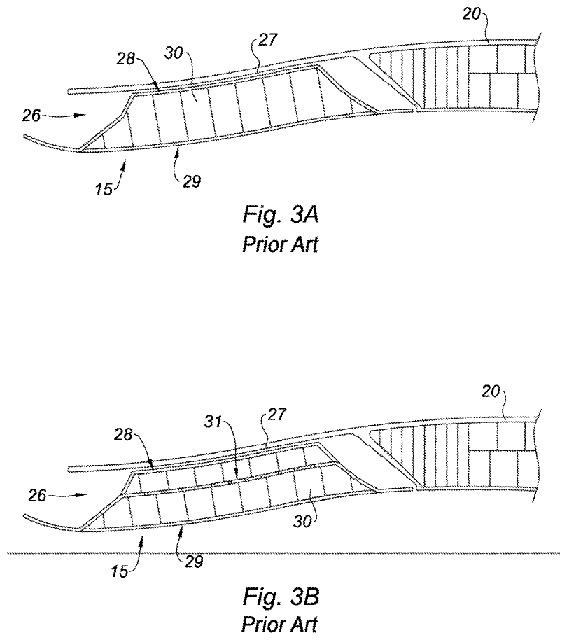

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

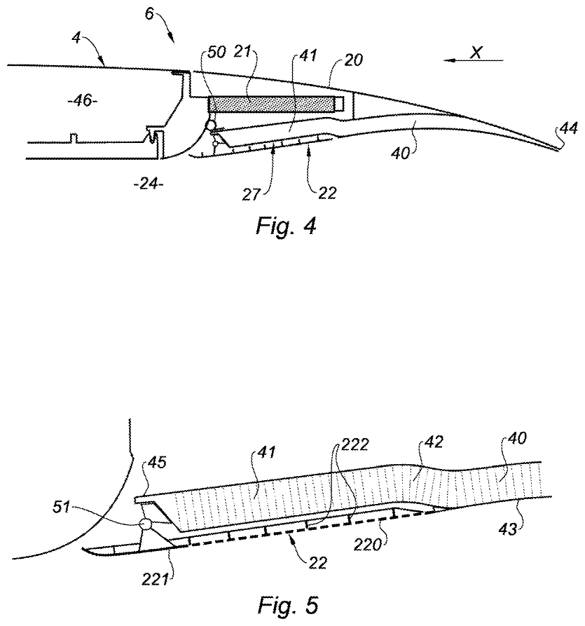

FIG. 4 shows a cross-section of a portion of a rear section 4 of a nacelle when the thrust reverser 6 is in the closed position (direct jet).

By convention, the terms “upstream” and “downstream,” as well as “front” and “rear” are understood relative to the direction of flow of the air flow through the nacelle.

The thrust reversal system 6 comprises a movable cowl 20, which forms the external surface of the rear section 4 of the nacelle.

The thrust reversal system 6 further comprises thrust reverser cascades 21 and thrust reverser flaps 22, rotatably movable, and associated with connecting rods (not illustrated).

The thrust reversal system 6 includes actuators (not represented), in particular electromechanical actuators, allowing to slide the movable cowl 20 mounted on a fixed structure of the reverser between a closed position, in which it provides the aerodynamic continuity of the nacelle 1 and an open position in which it opens a passage 61 in the nacelle 1, and vice versa.

This translation is performed along a longitudinal axis X of the nacelle 1, corresponding to the longitudinal axis of the engine.

The thrust reverser 6 is configured so that, in its retracted position:

the movable cowl 20 is in the closed position, corresponding to an advanced position in which it provides the aerodynamic continuity of the nacelle 1, in particular with the median section of the nacelle 1; and

the thrust reverser flaps 22 are in the retracted position, a position in which they are aligned with the inner wall 40 of the movable cowl 20, and housed in a housing of the movable cowl 20, when the movable cowl is in the closed position.

Furthermore, when the thrust reversal system 6 is in the deployed position:

the movable cowl 20 is in the open position, corresponding to a receded position, that is to say displaced backwards or downstream, in which it opens the passage 61 in the nacelle 1 and uncovers in particular the thrust reverser cascades 21;

and

the thrust reverser flaps 22 are in the deployed position, a position in which they are arranged to obstruct at least partially a flow path 24 of the cold flow of the nacelle 1 in order to divert at least a portion of the flow towards the passage 61 opened in the nacelle 1, more precisely through the thrust reverser cascades 21, when said movable cowl 20 is in the open position.

In this configuration, the action of thrust reverser flaps 22 and the thrust reverser cascades 21 allows to redirect the cold flow outside the nacelle 1, forwards AV in order to create a counter-thrust.

The passage into the deployed position of the thrust reverser flaps 22 is in the example obtained by the action of connecting rods attached to an inner fixed structure of the nacelle (not illustrated).

The housing 27 of the movable cowl 20 arranged to receive the thrust reverser flaps 22 in the closed position is delimited by a wall 41 of said movable cowl 20 at least partially formed, and in one form includes an acoustic attenuation panel, that is to say that the wall 41 at the level of said housing 27 is acoustically treated.

Thanks to this characteristic, it is then possible to dimension thrust reverser flaps 22 so that they are less bulky. In fact, the acoustic treatment of the thrust reverser flaps 22 can be accordingly reduced, the acoustic treatment being offset from the thrust reverser flaps 22 towards the wall 41 which delimits the housing 27 in the closed position.

The wall 41 of the movable cowl which delimits the housing has a composite sandwich structure forming an acoustic attenuation panel and is more precisely formed by a continuous extension of the acoustic attenuation panel of the inner wall 40 of the movable cowl 20 with which the thrust reverser flap is aligned when it is in the retracted position.

This wall 41 of the housing is more precisely composed of an acoustic attenuation panel continuously extending from said housing 27 which it delimits up to the inner wall 40, in particular up to a downstream end 44 of the movable cowl 20 forming trailing edge.

In other words, the inner wall 40 of the movable cowl 20 is formed by an acoustic composite panel and extends from the downstream end 44 forming a trailing edge up to upstream so as to form the housing 27 by delimiting it.

In this form, the acoustic composite panel extends upstream up to an upstream end 45 of the movable cowl 20 which substantially comes into contact with the fixed structure 46 of the rear section 4 of the nacelle in the closed position. In one form, the contact is indirect, by the presence of an interface defined by a sealing joint 50. The thrust reverser flaps 22 are secured to the movable cowl 20 by a pivot connection 51 (FIG. 5) substantially located at this upstream end 45.

More specifically, the acoustic composite panel comprises a downstream portion arranged to be swept by the secondary flow when the turbojet engine is in operation and the thrust reverser is in the closed position.

The acoustic panel extends from the downstream portion towards the upstream portion, upstream from the downstream portion, to delimit the housing 27 provided for receiving the thrust reverser flaps in the closed position.

Such longitudinal continuity of the acoustic attenuation panel between the upstream and downstream ends of a so-called “lower” wall of the movable cowl 20 forming the wall 41 delimiting the housing 27 and forming the inner wall 40 allows to gain in stiffness and in structural holding.

A step 42 of the acoustic panel separates the upstream portion from the downstream portion so that, in the retracted position of the thrust reverser flaps 22, the latter are aligned with the inner wall 40 of the movable cowl, in particular aligned with an inner surface 43 of the inner wall 40 provided to be swept by the secondary flow in operation. Indeed, this step 42 of the inner wall 40 is oriented towards the inside of the movable cowl so that the upstream portion of the acoustic panel is recessed towards the inside of the movable cowl relative to the downstream portion which is swept by the secondary flow in the closed position. In this closed position, it is this withdrawal from the upstream portion of the acoustic panel that creates a recess in the movable cowl 20 delimiting the housing 27.

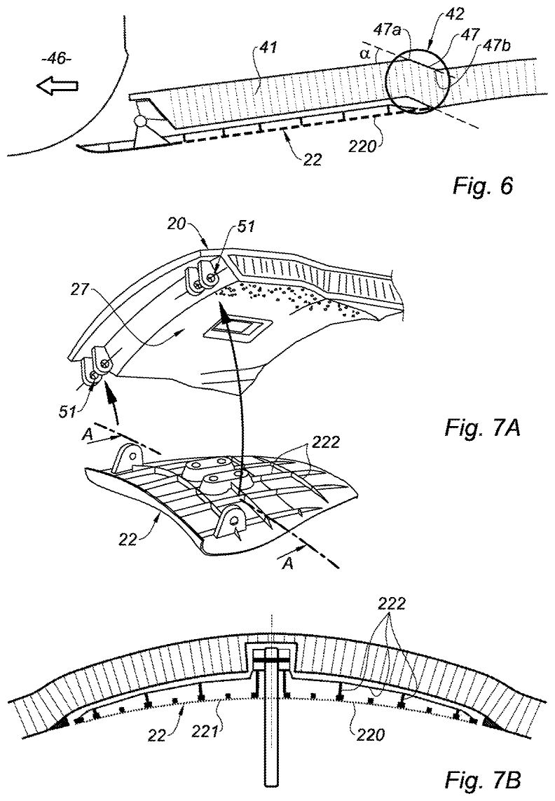

In other words, the step 42, as shown in FIG. 6, has an oblique wall 47 connecting the upstream and downstream portions of the acoustic panel, that is to say upstream connecting the wall 41 which delimits the housing 27 in the closed position and, downstream, the inner wall 40 of the movable cowl 20. The oblique wall 47 is connected:

upstream, to the wall 41 which delimits the housing 27 by an upstream curved shape 47a whose curvature is oriented towards the inside of the nacelle, that is to say that the center of curvature is located towards the inside of the nacelle relative to the movable cowl 20; and

downstream, to the inner wall 40 of the movable cowl 20 by a downstream curved shape 47b whose curvature is oriented towards the outside of the nacelle, that is to say that the center of curvature is located towards the outside of the nacelle relative to the movable cowl 20.

So as to improve the transition between the wall 41 forming housing 27 and the inner wall 40 of the movable cowl, that is to say which is both easy to shape, being a composite panel of the sandwich composite structure type, and having improved structural holding, the slope formed by the oblique wall 47 has an angle a less than or equal to 45 degrees relative to the walls 40, 41, at least locally at the level of the step 42.

The acoustic panel is formed by a sandwich structure, including a cellular core, for example of the honeycomb type, which is framed between two skins, one solid and the other perforated so as to be acoustically porous.

The perforated skin, generally called acoustic skin, is intended to be in contact with the cold air flow passing through the nacelle and/or with the flow of hot gases ejected by the turbojet engine. In the case of the acoustic skin of the acoustic attenuation panel forming the wall 41 of the housing 27, this is intended to be in contact with the cold air flow passing through the nacelle, when the movable cowl 20 is in the open position and the flaps 22 in the deployed position of course. Obviously, this acoustic skin is not swept by the cold air flow when the flap 22 is in the retracted position but it still provides a noise attenuation function.

The acoustic panel is here an acoustic attenuation panel with a single degree of freedom of acoustic waves (SDOF) but it can be supplemented or even replaced, as required by acoustic attenuation panels with a double degree of freedom (2 DOF or DDOF).

According to the nacelles, it should be noted that the movable cowls can have different configurations. A movable cowl 20 can indeed be of an almost annular shape, extending without interruption from one side to the other of a suspension mast of the assembly formed by the turbojet engine and its nacelle, such a cowl being called “O-duct,” referring to the shroud shape of such a cowl. Alternatively, the movable cowl 20 can also in fact comprise two half-cowls each extending over a semi-circumference of the nacelle, such a cowl being called “D-duct.”

Whatever the selected configuration for the nacelle, the acoustic attenuation panel forming the lower wall 45, 41, 42, 40, 44 of the movable cowl 20 extends:

axially continuously, that is to say without discontinuity, between the upstream and downstream ends of the wall of the movable cowl 20 forming from upstream towards downstream, the wall 41 delimiting the housing 27, the oblique wall 47 and the inner wall 40 to the trailing edge 44, and also extends

circumferentially continuously, either in the almost annular shape from one side to the other of the suspension pylon in the case of an “O-duct,” or along the semi-circumference of the nacelle in the case of a “D-duct.”

In any event, the acoustic attenuation panel taking the shape of a sandwich structure as described is intended to form the lower wall of the associated movable cowl in one piece. In other words, once the sandwich structure is formed, which in one form is by brazing, and in particular after brazing, it forms an assembly in one piece, therefore without attached part, forming the lower wall 45, 41, 42, 40, 44 of the movable cowl 20. It will be noted that other manufacturing methods can be used to obtain the lower wall of the movable cowl as described.

The thrust reverser flaps 22 are acoustically transparent, that is to say that they are permeable to sound frequencies. In other words, this means that the thrust reverser flaps 22 are not acoustically treated, which is possible insofar as the acoustic treatment is offset on the wall 41 delimiting the housing 27 where the flaps 22 are positioned in the closed position.

This configuration is particularly advantageous so that the noise attenuation function by the area of the acoustic attenuation panel forming the wall 41 of the housing 27 is also effective when the flaps 22 are in the retracted position, because they are acoustically transparent.

More specifically, the thrust reverser flaps have a pierced and/or porous surface 220 consequently making the thrust reverser flaps 22 generally acoustically transparent. An acoustic path is therefore defined from the flow path of cold flow to the wall 41 delimiting the housing 27, this through the flaps 22.

In this configuration, the thrust reverser flaps 22 are formed by a monolithic wall 221, for example made of metallic, composite, thermoplastic material(s), etc.

To improve its structural holding to the forces exerted on the thrust reverser flaps 22, the monolithic wall is reinforced by stiffeners 222 (best shown in FIGS. 7A and 7B).

The movable cowl 20 according to the present disclosure therefore has a homogeneous structure unlike the prior art, whose lower wall is heterogeneous since it has an acoustically treated inner wall and a housing for the doors which is formed from attached partitions.

Furthermore, the present disclosure allows, in addition to a homogeneity of the lower wall of the translating cowl, to improve the acoustically treated surfaces and to simplify the manufacture of the movable cowl so as to avoid the steps of manufacturing and fixing attached elements, that the manufacture of thrust reverser flaps which have a simplified structure.

The present disclosure is described in the foregoing by way of example. It is understood that one skilled in the art is able to carry out different variants of the present disclosure without departing from the scope of the present disclosure.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A thrust reverser for a turbojet engine nacelle comprising at least one movable cowl mounted on a fixed structure of the thrust reverser between a closed position, in which the at least one movable cowl provides an aerodynamic continuity of the turbojet engine nacelle, and an open position in which the at least one movable cowl opens a passage in the turbojet engine nacelle, the thrust reverser comprising:
thrust reverser flaps actuated by sliding of the at least one movable cowl, the thrust reverse flaps being movable between:
a retracted position, in which the thrust reverser flaps are aligned with an inner wall of the at least one movable cowl, and housed in a housing of the at least one movable cowl, when the at least one movable cowl is in the closed position; and
a deployed position, in which the thrust reverser flaps at least partially obstruct a cold air flow path of the turbojet engine nacelle to at least partially divert air flow towards the passage opened in the turbojet engine nacelle, when the at least one movable cowl is in the open position,
wherein the housing of the at least one movable cowl is delimited by a wall of the at least one movable cowl, wherein the wall is at least partially formed by an acoustic attenuation panel.

2. The thrust reverser according to claim 1, wherein the wall of the at least one movable cowl is formed by a continuous extension of the inner wall of the at least one movable cowl.

3. The thrust reverser according to claim 2, wherein the wall of the at least one movable cowl is formed by an acoustic attenuation panel continuously extending from the housing to the inner wall.

4. The thrust reverser according to claim 1, wherein the thrust reverser flaps are acoustically transparent.

5. The thrust reverser according to claim 4, wherein the thrust reverser flaps have a pierced surface.

6. The thrust reverser according to claim 4, wherein the thrust reverser flaps have a porous surface.

7. The thrust reverser according to claim 1, wherein the thrust reverser flaps are formed by a monolithic wall.

8. The thrust reverser according to claim 7, wherein the thrust reverser flaps are reinforced by stiffeners.

9. A nacelle comprising a thrust reverser according to claim 1.
